(19) United States
(12) Patent Application Publication
(10) Pub. No.: US 2013/0162573 A1
(43) Pub. Date: Jun. 27, 2013

(54) DISPLAY DEVICE AND ITS MOVEMENT DETECTING METHOD FOR REMOTE OBJECT

(71) Applicants: Innocom Technology (Shenzhen) Co., Ltd., Shenzhen City (CN); Chimei Innolux Corporation, Chu-Nan (TW)

(72) Inventor: Kung-Chieh HUANG, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/725,236

(22) Filed: Dec. 21, 2012

(30) Foreign Application Priority Data
Dec. 23, 2011 (TW) 100148401

(51) Int. Cl. G06F 3/041

(52) U.S. Cl. CPC G06F 3/041
USPC 345/173

(57) ABSTRACT

A display device comprises a display module, at least two sensing devices and a control module. The sensing devices are disposed at the opposite sides or the adjacent sides of the display module. The control module is coupled with the sensing devices to respectively detect coupling capacitances formed between the sensing devices and a remote object, and determines the movement of the remote object according to the coupling capacitances.

### CROSS REFERENCE TO RELATED APPLICATIONS

This Non-provisional application claims priority under 35 U.S.C. §119(a) on Patent Application No(s). 100148401 filed in Taiwan, Republic of China on Dec. 23, 2011, the entire contents of which are hereby incorporated by reference.

### BACKGROUND

1. Field

The invention relates to a display device and a detecting method of an object and, in particular, to a display device and a movement detecting method for a remote object.

2. Related Art

Motion sensing is recently used as a kind of input interface receiving the body motion or the reaction, different from the conventional input devices, such as keyboards, joysticks, or mouse.

Motion sensing can be applied to the computer games or displaying. In general, the display device or the game machine needs to be configured with an additional motion sensing device that they can be capable of the motion sensing function.

As for the game machine, its motion sensing module includes an optical image device which can capture the image of a user and then transmit the image content to the game machine. Then, the game machine can analyze the user's motion according to the image content, so the games can be controlled by the user's motion as the input information. Besides, the game's content displayed by the display device is variable according to the input information.

The motion sensing device of the game machine is usually disposed near the display device, such as over the display device or below the display device, so that the user can control the game by the motion sensing device sensing the user's motion.

However, it is unavoidable, nowadays, to add a motion sensing device to the display device or the game machine. Even if the motion sensing device is very near the display device, it still needs to be disposed outside the display device.

Therefore, it is an important subject to provide a display device and a movement detecting method without the need to add a motion sensing device while the display device is capable of motion sensing.

### SUMMARY

In view of the foregoing subject, an objective of the invention is to provide a display device and a method that can effectively detect the movement of the remote object.

To achieve the above objective, a display device of the invention comprises a display module, at least two sensing devices, and a control module. The sensing devices are disposed at the opposite sides or the adjacent sides of the display module. The control module is coupled with the sensing devices to respectively detect coupling capacitances formed between the sensing devices and a remote object, and determines the movement of the remote object according to the coupling capacitances.

To achieve the above objective, a movement detecting method for a remote object of a display device, which includes a display module and at least two sensing devices disposed at the opposite or adjacent sides of the display module, comprises: a detecting step respectively detecting coupling capacitances formed between the sensing devices and the remote object; and a determining step determining the movement of the remote object according to the coupling capacitances.

As mentioned above, in the display device of the invention, at least two sensing devices are disposed at the opposite sides or the adjacent sides of the display module, and they can form coupling capacitances with the remote object. Accordingly, the movement of the remote object can be determined by detecting the variation of the coupling capacitances. Therefore, the display device of the invention is capable of motion sensing.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a display device according to an embodiment of the invention;

FIG. 2A is a schematic diagram of a unit sensing pad of the touch panel of the display module as shown in FIG. 1;

FIG. 2B is a schematic diagram of the sensing device as shown in FIG. 1;

FIG. 3 is a schematic diagram of the display device as shown in FIG. 1 and a remote object;

FIG. 4A is a schematic diagram of the waveforms of the coupling capacitances of the display device according to an embodiment of the invention;

FIG. 4B is a flow chart of the movement detecting method for the remote object, according to an embodiment of the invention, of the display device;

FIG. 5A is another schematic diagram of the waveforms of the coupling capacitances of the display device according to the embodiment of the invention;

FIG. 5B is a flow chart of another aspect of the movement detecting method for the remote object of the display device according to an embodiment of the invention;

FIG. 6 is a flow chart of another aspect of the movement detecting method for the remote object, according to an embodiment of the invention, of the display device; and

FIGS. 7A to 7D are schematic diagrams of various dispositions of the sensing devices according to an embodiment of the invention.

### DETAILED DESCRIPTION

The present invention will be apparent from the following detailed description, which proceeds with reference to the accompanying drawings, wherein the same references relate to the same elements.

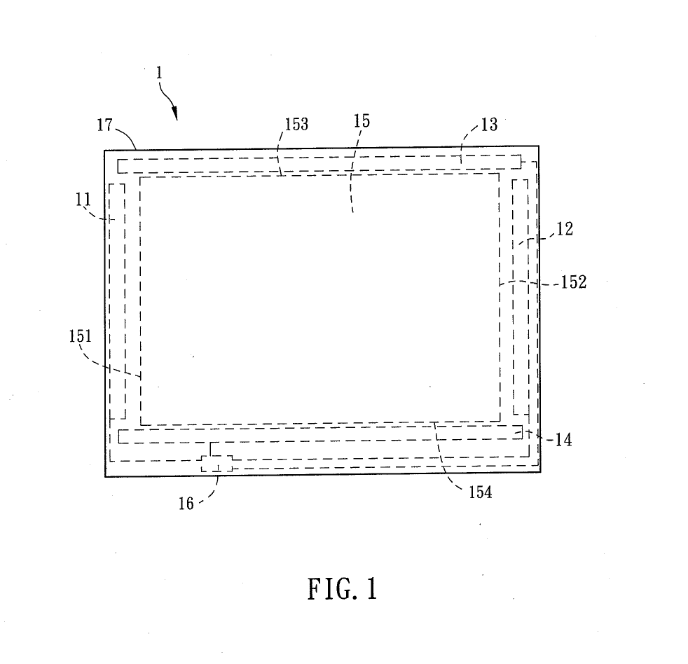

FIG. 1 is a schematic diagram of a display device according to an embodiment of the invention. As shown in FIG. 1, the display device 1 includes a display module 15, a plurality of sensing devices 11 to 14, a control module 16, and a housing 17. The number of the sensing devices is two or more, and is instanced as 4 in the embodiment. The sensing devices are disposed at the opposite sides. For example, the sensing devices 11 and 12 are disposed at the horizontal opposite sides 151 and 152, and the sensing devices 13 and 14 are disposed at the vertical opposite sides 153 and 154. The control module 16 is coupled with the sensing devices 11 to 14 to detect an coupling capacitance formed between each of the sensing devices 11 to 14 and an remote object. The control module 16 determines the movement of the remote object according to the coupling capacitances.

The sensing devices 11 and 12 are used to detect the movement of the remote object along a horizontal direction, and the sensing devices 13 and 14 are used to detect the movement of the remote object along a vertical direction. The horizontal direction and the vertical direction indicate the possible moving directions of the remote object relative to the display module 15.

To be noted, in a practical situation, the coupling capacitance can include the voltage difference or time difference detected by an IC chip due to the charging and discharging. Those skilled in the art can understand several physical measurements derivative from or equivalent to the coupling capacitance can be detected and are included in the coupling capacitance.

The housing 17 contains the display module 15, the sensing devices 11 to 14, and the control module 16. The sensing devices 11 to 14 are disposed in a non-display area of the display module 15, and covered by the rims of the housing 17. The sensing devices 11 to 14 can be metal sheets, but they can't affect the display effect of the display module 15. Besides, they are not exposed from the housing 17, so the user can not see the sensing devices 11 to 14.

The display module 15 can be a flat display module, such as an LCD (liquid crystal display) module, an electroluminescent display module, or a plasma display module. The display module 15 also can be a touch display module, which can be the said display modules added with a touch sensing function. Either the flat display module or the touch display module is a semi-finished product, so the user can not use or buy them. Generally, the flat display module needs to be assembled with the housing to form a finished product that can be provided to the user.

The display device 1 can be a finished product, such as a monitor or a television, which the user can buy or use. The housing 17 is an outer casing of the finished product, and generally the housing 17 will not be covered by an additional casing.

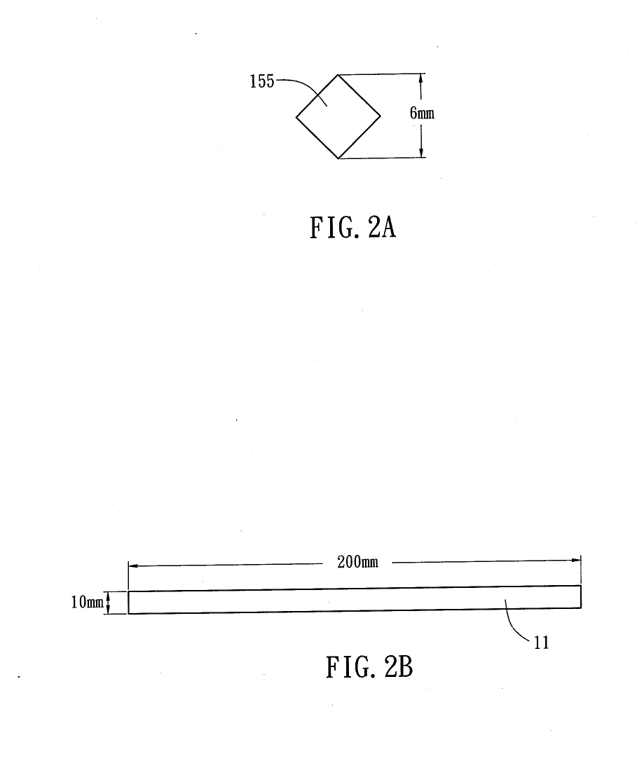

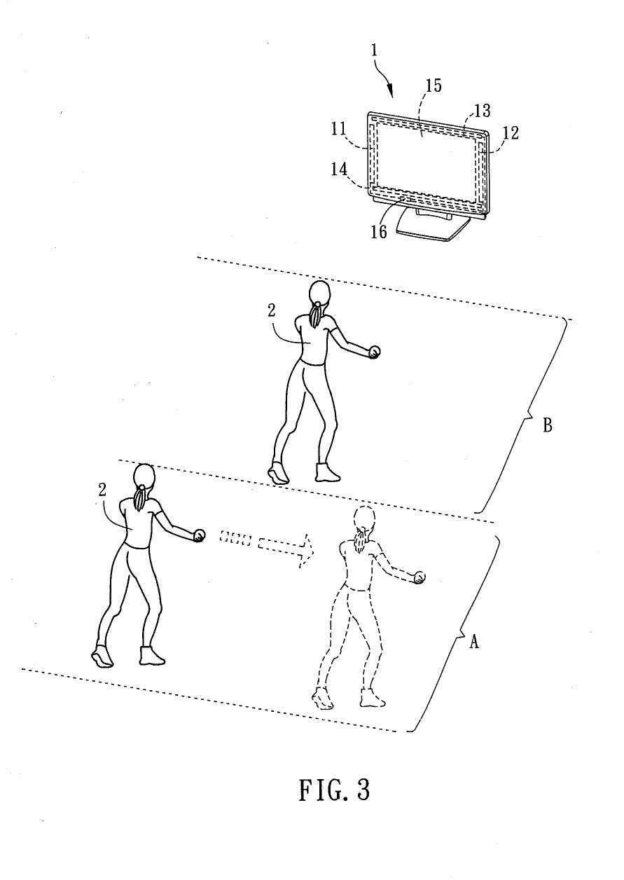

FIG. 2A is a schematic diagram of a unit sensing pad of the touch panel of the display module 15 as shown in FIG. 1, and FIG. 2B is a schematic diagram of the sensing device 11 as shown in FIG. 1. As shown in FIG. 2A, the display module 15 includes a touch panel having a plurality of unit sensing pads 155, which are used to form the coupling capacitance with an external object, such as a finger. The coupling capacitance's value has positive correlation with the area of the unit sensing pad 155. The unit sensing pad 155 can have, for example, a rhombus shape with a diagonal 6 mm and an area about 18 mm2.

As shown in FIG. 2B, because the sensing device 11 is disposed outside the display area, its effective area for forming the coupling capacitance is far larger than the area of the unit sensing pad 155 that is disposed in the touch panel. Each of the sensing devices 11 to 14 has an area larger than fifty times the area of the unit sensing pad 155. For example, the length of the sensing device 11 is 200 mm, the width of which is 100 mm, and the area of which is about 2000 mm2. Accordingly, if the remote object is farther from the display device 1, the unit sensing pad 155 can not form the effective coupling capacitance, but the sensing devices 11 to 14 can still form the effective coupling capacitance with the remote object. The sizes of the unit sensing pad 155 and the sensing device 11 as mentioned above are just for example and not for limiting the scope of the invention.

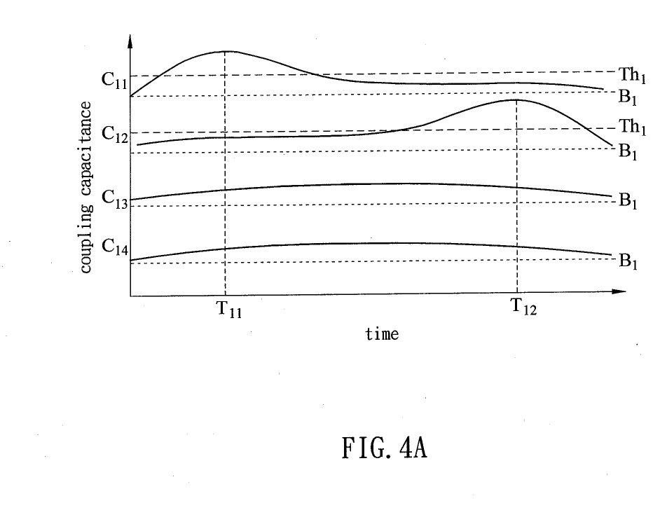

FIG. 3 is a schematic diagram of the display device 1 as shown in FIG. 1 and a remote object 2. As shown in FIG. 3, the coupling capacitance is inversely proportional to the distance between the remote object and the sensing devices 11 to 14. For example, the remote object 2 is a user, and when the user is getting closer to the display device 1, the distance between the user and the sensing devices 11 to 14 is getting smaller, thereby making the coupling capacitance increased. Once the user is so close to the display device 1 that the coupling capacitance is increased to a sufficient level, the coupling capacitance can serve as the effective signal for the movement of the remote object 2.

For example, the control module 16 determines the movement of the remote object 2 parallel to the display device 1 according to the coupling capacitances and a threshold value. Besides, the control module 16 can determine the movement of the remote object 2 parallel to the display device 1 according to the difference of the variation of the coupling capacitances. Furthermore, the control module 16 can determine if the remote object 2 approaches or leaves the display device 1 according to the sum of the variation of the coupling capacitances. The said movement detecting methods for the remote object 2 can be used individually or together. Some examples are illustrated as below.

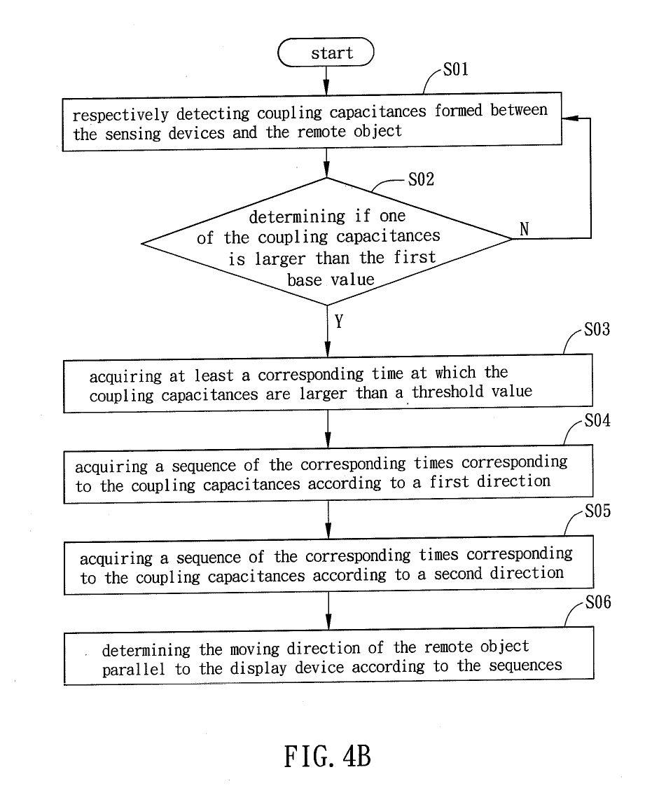

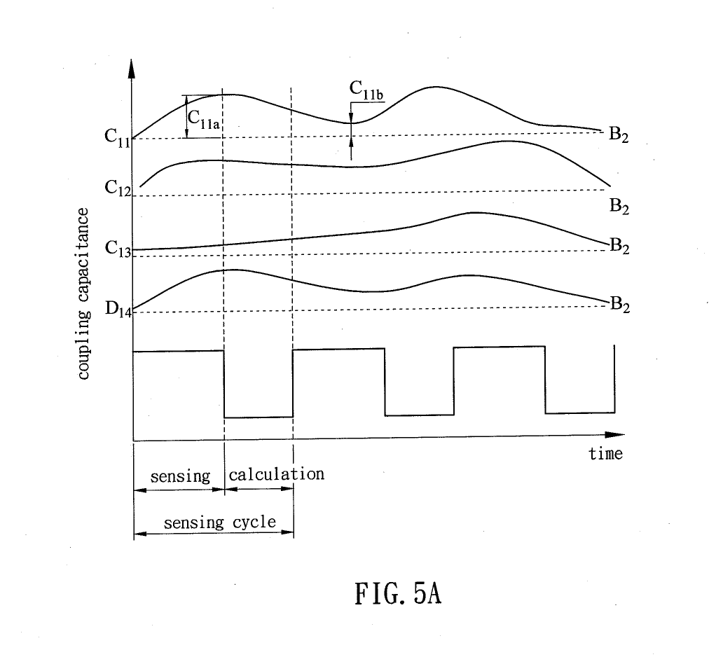

FIG. 4A is a schematic diagram of the waveforms of the coupling capacitances of the display device according to an embodiment of the invention. As shown in FIG. 4A, when one of the coupling capacitance is larger than a first base value B1, the control module 16 determines the movement of the remote object 2 parallel to the display device 1 according to the coupling capacitances and a threshold value TH1. The first base value B1 represents a coupling capacitance formed by the environment and the sensing devices. To be noted, if the coupling capacitances C11 to C14 formed by the remote object 2 and the sensing devices 11 to 14 are larger than the coupling capacitance formed by the environment and the sensing devices 11 to 14, they can function as the effective input.

For example, when the user (as the remote object) is disposed in the area A as shown in FIG. 3, the user and the sensing devices 11 to 14 can form a sufficient coupling capacitance C11 to C14. In this case, if one of the coupling capacitances is larger than the first base value B1, the user's movement can be approximately determined, such as upward, downward, leftward, or rightward movement, which is parallel to the display device. This kind of detection can be applied to the determination of the hand gesture, item selection, or page turning.

As shown in FIGS. 3 and 4A, the user is located opposite to the left side of the display device 1 at the time T11, and thus the coupling capacitance between the sensing device 11 and the user is larger than the coupling capacitances between the sensing devices 12 to 14 and the user. After a period, the user is located opposite to the right side of the display device 1 at the time T12, and thus the coupling capacitance between the sensing device 12 and the user is larger than the coupling capacitances between the sensing devices 11 and 13 to 14 and the user. Accordingly, the user's movement can be detected by determining the sequence in which the coupling capacitances C11 to C14 exceed the threshold value TH1.

FIG. 4B is a flow chart of the movement detecting method for the remote object of the display device according to an embodiment of the invention, conforming to the condition as shown in FIG. 4A for example. As shown in FIG. 4B, the detecting method includes the steps S01 to S06.

The step S01 is to respectively detect coupling capacitances formed between the sensing devices and the remote object.

The step S02 is to determine if one of the coupling capacitances is larger than the first base value. The method will go to the step S03 if at least one of the coupling capacitances is larger than the first base value, and if not, the method will go back to the step S01.

The step S03 is to acquire at least a corresponding time at which the coupling capacitances are larger than a threshold value.

The step S04 is to acquire a sequence of the corresponding times corresponding to the coupling capacitances according to a first direction.

The step S05 is to acquire a sequence of the corresponding times corresponding to the coupling capacitances according to a second direction.

The step S06 is to determine the moving direction of the remote object parallel to the display device according to the sequences.

The control module 16 can repeatedly detect the coupling capacitances C11 to C14 formed between the sensing devices 11 to 14 and the remote object 2, and calculate the coupling capacitances C11 to C14. When one of the coupling capacitances is larger than the first base value B1, the detecting method will go to the first determining mode. These steps can be operated by the control module 16.

The first determining mode includes the steps S03 to S06. In the first determining mode, the moving direction of the remote object 2 parallel to the display device 1 can be determined according a sequence in which the coupling capacitances C11 to C14 exceed a threshold value Th1. The first determining mode can be applied to the determination of the hand gesture or the moving direction.

In the step S03, as shown in FIG. 4A, the coupling capacitance C11 can be found larger than the threshold value Th1 at the time T11, and the coupling capacitance C12 can be found larger than the threshold value Th1 at the time T12. Then, in the step S04, whether the remote object 2 moves along the first direction, such as the horizontal direction, is determined by correspondingly using the sensing devices 11 and 12 and the coupling capacitances C11 and C12. In the step S04, a sequence in which the coupling capacitances C11 and C12 exceed the threshold value Th1 can be acquired by comparing the magnitudes of the times T11 and T12, and this sequence can represent the movement along the horizontal direction of the remote object 2.

The steps S03 and S04 can be represented by the following logic, wherein the positive and negative signs of X represent the moving directions of the horizontal direction.
if (C₁₁>Th₁, C₁₂>Th₁ and T₁₁<T₁₂) then X is +
else if (C₁₁>Th₁, C₁₂>Th₁ and T₁₁>T₁₂) then X is −

Then, the step S05 similar to the step S04 is to determine if the remote object 2 moves along the second direction, such as the vertical direction, by correspondingly using the sensing devices 13 and 14 and the coupling capacitances C13 and C14. In the step S05, a sequence in which the coupling capacitances C13 and C14 exceed the threshold value Th1 can represent the movement along the vertical direction of the remote object 2.

The steps S03 and S05 can be represented by the following logic, wherein T13 and T14 denote the times at which the coupling capacitances C13 and C14 are respectively larger than the threshold value Th1, and the positive and negative signs of Y represent the moving directions of the vertical direction.
if (C₁₃>Th₁, C₁₄>Th₁ and T₁₃>T₁₄) then Y is +
else if (C₁₃>Th₁, C₁₄>Th₁ and T₁₃<T₁₄) then Y is −

Based on the results of the steps S04 and S05, the moving direction of the remote object 2 can be determined according to the values of X and Y in the step S06. Several examples are illustrated as below.
If (X, Y) is (+, 0), the moving direction is rightward direction.
If (X, Y) is (+, +), the moving direction is toward the upper right.
If (X, Y) is (0, −), the moving direction is downward direction.

In this case, “+” means moving rightwards or upwards, “−” means moving leftwards or downwards, and “0” means no movement is sensed.

Besides, the detecting method can include calculating a time difference of the corresponding times and determining the velocity of the remote object according to the time difference. So, the first determining mode also includes determining the velocity.

For example, the horizontal velocity of the remote object 2 can be derived from the time difference between the times T11 and T12, and the vertical velocity of the remote object 2 can be derived from the time difference between the times T13 and T14.

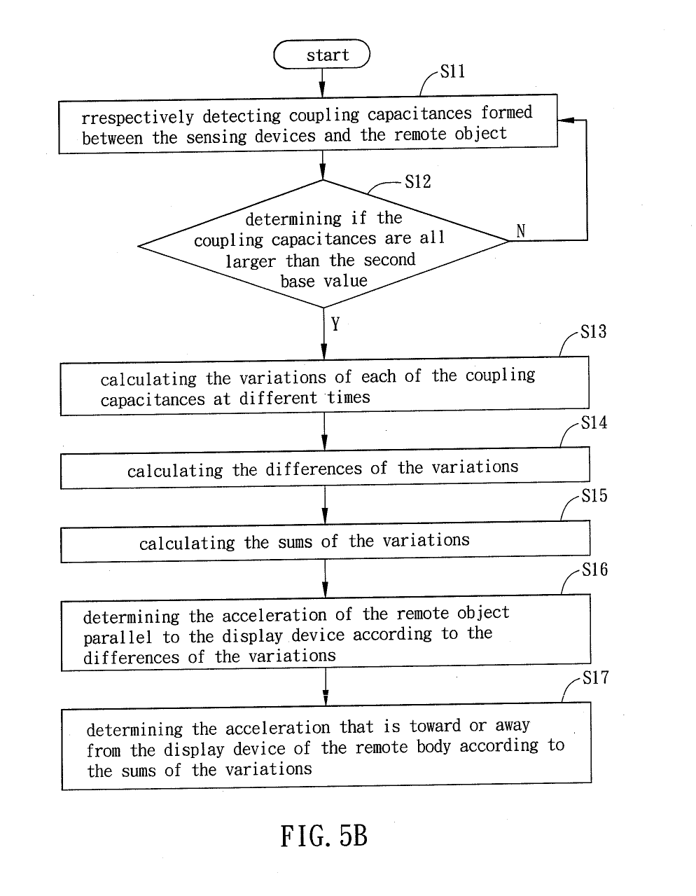

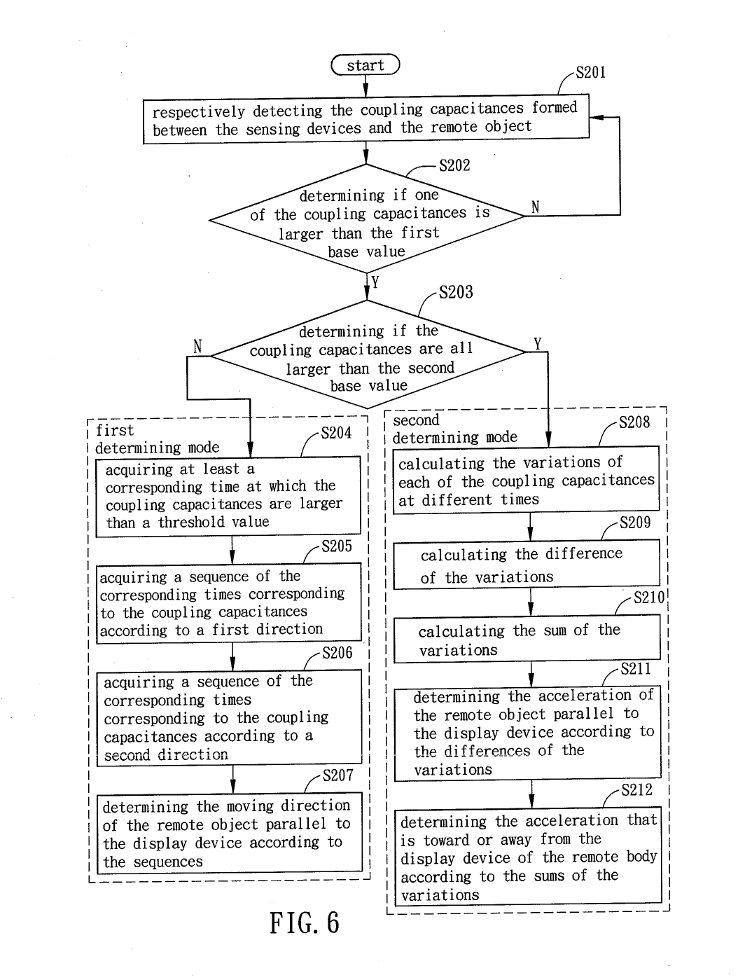

FIG. 5A is a schematic diagram of waveforms of the coupling capacitances of the display device according to an embodiment of the invention. As shown in FIG. 5A, when the coupling capacitances C11 to C14 are all larger than a second base value B2, the control module 16 determines the movement of the remote object 2 parallel to the display device 1 according to the difference of the variation of the coupling capacitances C11 to C14. Besides, the control module 16 also determines if the remote object 2 approaches or leaves the display device 1 according to the sum of the variation of the coupling capacitances C11 to C14.

The second base value B2 represents the coupling capacitance formed by the environment and the sensing devices. The second base value B2 is larger than the first base value B1 for assuring each of the coupling capacitances C11 to C14 can serve as the effective input.

As shown in FIGS. 3 and 5A, for example, when the user (as the remote object 2) is located in the area B as shown in FIG. 3, the user and the sensing devices 11 to 14 can form a larger coupling capacitance than the area A. In this case, the coupling capacitances C11 to C14 are not only larger than the first base value B1, but also larger than the second base value B2, so that the user's movement can be accurately determined. Accordingly, not only the upward, downward, leftward, and rightward movements of the user can be determined, but also the frontward and rearward movements can be determined. In other words, not only the user's movements parallel to the display device can be determined, but also the user's movements toward or away from the display device can be determined. Besides, the acceleration of the user can be determined.

FIG. 5B is a flow chart of another aspect of the movement detecting method for the remote object of the display device according to the embodiment of the invention, conforming to the condition as shown in FIG. 5A for example. As shown in FIG. 5B, the detecting method includes the steps S11 to S17.

The step S11 is to respectively detect coupling capacitances formed between the sensing devices and the remote object.

The step S12 is to determine if the coupling capacitances are all larger than the second base value, wherein the method goes to the step S13 if the coupling capacitances are all larger than the second base value, and if not, the method goes back to the step S11.

The step S13 is to calculate the variations of each of the coupling capacitances at different times.

The step S14 is to calculate the differences of the variations.

The step S15 is to calculate the sums of the variations.

The step S16 is to determine the acceleration of the remote object parallel to the display device according to the differences of the variations.

The step S17 is to determine the acceleration that is toward or away from the display device of the remote body according to the sums of the variations.

The control module 16 can repeatedly detect the coupling capacitances C11 to C14 formed between the sensing devices 11 to 14 and the remote object 2, and calculate the coupling capacitances C11 to C14. When the coupling capacitances are all larger than the second base value B2, the detecting method goes to the second determining mode. These steps can be operated by the control module 16.

The second determining mode includes the steps S13 to S17, which derive the accelerations of the remote object 2 from the variations of the coupling capacitances C11 to C14, and can be applied to the control and positioning requiring more accuracy.

In the step S13, as shown in FIG. 5A, each of the coupling capacitances C11 to C14 is cyclically detected and thus the variations can be calculated. For example, in the first cycle, the coupling capacitances C11 is detected as C11a, and in the second cycle, it is detected as C11b, so the variation D11 can be derived by subtracting C11a detected earlier from C11b detected later, conforming to the equation as follows:

D11=C11b−C11a

In the same method, the variations D12 to D14 can be calculated by using the coupling capacitances C12 to C14.

In the step S14, the differences of the variations D11 to D14 can be calculated, respectively according to a first direction and a second direction, by using the coupling capacitances C11 to C14. The first direction and the second direction are, for example, the horizontal direction and the vertical direction, respectively. The first direction is corresponding to the coupling capacitances C11 and C12, and the second direction is corresponding to the coupling capacitances C13 and C 14. The difference of the variations according to the first direction means D11−D12, and the difference of the variations according to the second direction means D13−D14.

In the step S15, the variations D11 to D14 are summed up, and the sum indicates the remote object 2 leaves or approaches the display device 1 along a third direction.

In the step S16, the difference of the variations (D11−D12) along the first direction is multiplied by a proportional constant kx to derive the acceleration ax of the remote object along the first direction, and difference of the variations (D13−D14) along the second direction is multiplied by a proportional constant ky to derive the acceleration ay of the remote object along the second direction. In the step S17, the sum of the variations (D11+D12+D13+D14) is multiplied by a proportional constant kz to derive the acceleration az of the remote object along the third direction. The steps S16 and S17 use the equations as follows:

aₓ=kₓ (D₁₁−D₁₂)

a_{y}=k_{y} (D₁₃−D₁₄)

a_{z}=k_{z} (D₁₁+D₁₂+D₁₃+D₁₄)

In this mode, the sensing devices 11 and 12 and the sensing devices 13 and 14 are provided for the detections of the horizontal direction and vertical direction respectively. Besides, the all sensing devices 11 to 14 are provided for the detections of the frontward and rearward directions.

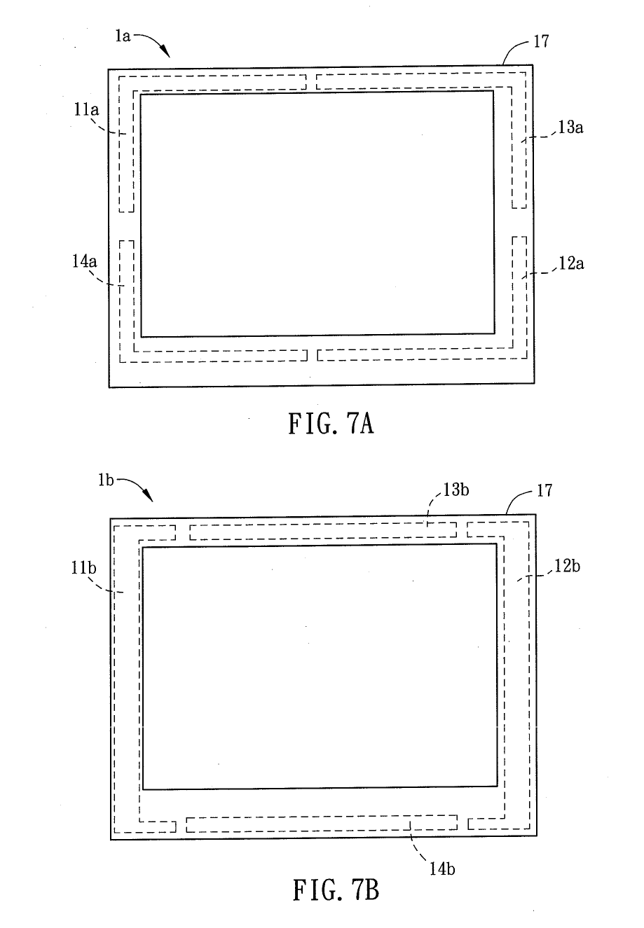

FIG. 6 is a flow chart of another aspect of the movement detecting method for the remote object of the display device according to the embodiment of the invention. As shown in FIG. 6, the display device can determine the movement of the remote object by two modes. The detecting method includes the steps S201 to S212.

The step S201 is to respectively detect the coupling capacitances formed between the sensing devices and the remote object. The steps S202 and S203 are to select a first determining mode or a second determining mode according to the coupling capacitances. Accordingly, the first determining mode (the steps S204 to S207) or the second determining mode (the steps S208 to S212) can be used to determine the movement of the remote object.

The step S202 is to determine if at least one of the coupling capacitances is larger than the first base value. If the determination result is true, the detecting method goes to the step S203 with the first determining mode, and if not, the detecting method will go to the step S201.

The step S203 is to determine if the coupling capacitances are all larger than the second base value that is larger than the first base value. If the coupling capacitances are all larger than the second base value, the detecting method goes to the second determining mode including the steps S208 to S212, and if not, the detecting method will go to the first determining mode including the steps S204 to S207.

Because the steps S204 to S207 of the first determining mode are similar to the above-mentioned steps S03 to S06 as shown in FIG. 4B, and the steps S208 to S212 of the second determining mode are similar to the above-mentioned steps S13 to S17 as shown in FIG. 5B, the detailed descriptions are omitted here.

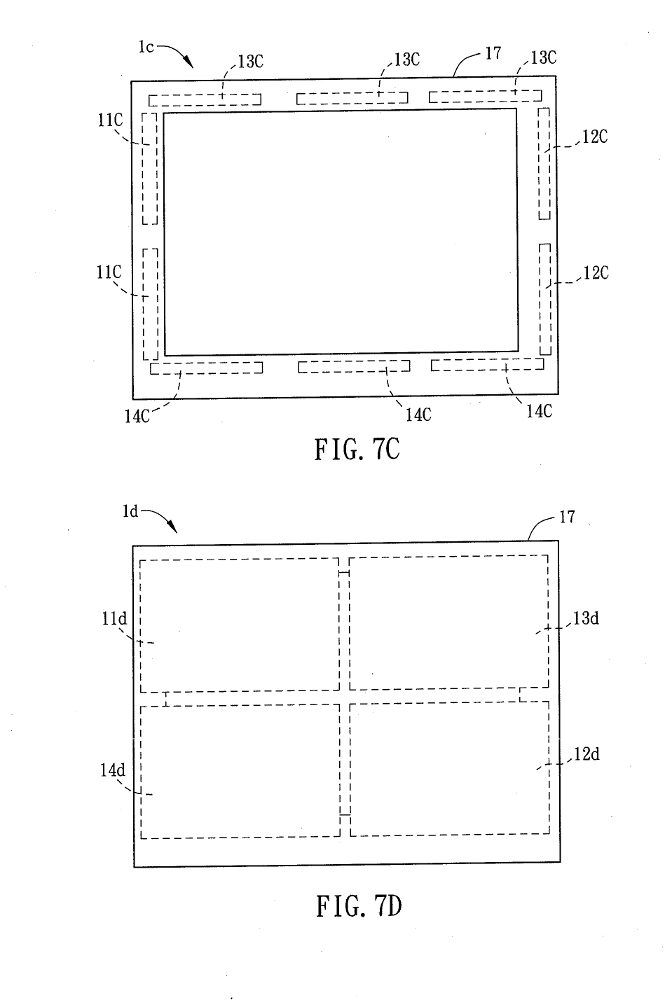

In the embodiment, the sensing device's area is preferably larger than 300 mm2. The sensing devices can have various dispositions. FIGS. 7A to 7D are schematic diagrams of the sensing devices with various dispositions according to the embodiment of the invention, and the sensing devices are disposed at the opposite sides or the adjacent sides of the display module. As shown in FIGS. 7A to 7C, the sensing devices are disposed outside the display area, i.e. the non-display area. In FIG. 7A, the sensing devices 11a to 14a are disposed in the housing 17 and at the corners of the housing 17. In FIG. 7B, the sensing devices 11b and 12b are respectively extended from one corner to another corner of the housing 17. Besides, the sensing devices 11b and 12b can have a width larger than the widths of the sensing devices 13b and 14b. In FIG. 7C, the number of the sensing devices is increased, and for example, two or more sensing devices can be disposed at the same side. Herein, the plural sensing devices 11c and 12c are disposed at the left side and the right side of the housing 17 respectively, and the plural sensing devices 13c and 14c are disposed at the upper side and the lower side of the housing 17. In the invention, the sensing device can be made of metal or other conducting material.

As shown in FIG. 7D, the sensing devices 11d to 14d can be partially disposed in the display area of the display module, and in this case the sensing device can be made of transparent conducting material, such as Indium Tin Oxide (ITO). The sensing devices 11d to 14d can be integrated with the display module.

In summary, in the display device of the invention, at least two sensing devices are disposed at the opposite sides or the adjacent sides of the display module, and they can form coupling capacitances with the remote object. Accordingly, the movement of the remote object can be determined by detecting the variation of the coupling capacitances. Therefore, the display apparatus of the invention is capable of motion sensing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a display module;
at least two sensing devices disposed at the opposite sides or the adjacent sides of the display module; and
a control module coupled with the sensing devices to respectively detect coupling capacitances formed between the sensing devices and a remote object, and determining the movement of the remote object according to the coupling capacitances.

2. The display device as recited in claim 1, wherein the control module determines a moving direction of the remote object parallel to the display device according a sequence in which the coupling capacitances exceed a threshold value.

3. The display device as recited in claim 1, wherein the control module determines a velocity of the remote object according to a time difference between the times at which the coupling capacitances exceed a threshold value.

4. The display device as recited in claim 1, wherein the control module calculates variations of each of the coupling capacitances at different times, and calculates the difference of the variations to determine an acceleration of the remote object parallel to the display device.

5. The display device as recited in claim 1, wherein the control module calculates the variation of each of the coupling capacitances at different times, and determines if the remote object moves approaches or leaves the display device according to a sum of the variations.

6. The display device as recited in claim 1, wherein
when at least one of the coupling capacitances is larger than a first base value, the control module determines the moving direction of the remote object parallel to the display device according to a sequence in which the coupling capacitances exceed a threshold value; and
when the coupling capacitances are all larger than a second base value that is larger than the first base value, the control module calculates variations of each of the coupling capacitances at different times, calculates a difference of the variations to determine an acceleration of the remote object parallel to the display device, and determines if the remote object approaches or leave the display device according to a sum of the variations.

7. The display device as recited in claim 1, wherein
when at least one of the coupling capacitances is between a first base value and a second base value, the control module determines the movement of the remote object according to the coupling capacitances, conforming to a first determining mode; and
when the coupling capacitances are all larger than a second base value that is larger than the first base value, the control module automatically changes to a second determining mode to determine the movement of the remote object according to the coupling capacitances.

8. The display device as recited in claim 1, wherein the number of the sensing devices is four or more, two of the sensing devices are disposed at the horizontal opposite sides of the display module for detecting the movement of the remote object along a horizontal direction, and the other two sensing devices are disposed at the vertical opposite sides of the display module for detecting the movement of the remote object along a vertical direction.

9. A movement detecting method for a remote object by using a display device, which includes a display module and at least two sensing devices disposed at the opposite or adjacent sides of the display module, comprising:
a detecting step respectively detecting coupling capacitances formed between the sensing devices and the remote object; and
a determining step determining the movement of the remote object according to the coupling capacitances.

10. The movement detecting method as recited in claim 9, wherein the determining step includes:
acquiring at least a corresponding time at which the coupling capacitances are larger than a threshold value;
acquiring a sequence of the corresponding times; and
determining the moving direction of the remote object parallel to the display device according to the sequence.

11. The movement detecting method as recited in claim 9, wherein the determining step includes:
acquiring at least a corresponding time at which the coupling capacitances are larger than a threshold value;
calculating a time difference of the corresponding times; and
determining a velocity of the remote object according to the time difference.

12. The movement detecting method as recited in claim 9, wherein the determining step includes:
calculating variations of each of the coupling capacitances at different times;
calculating a difference of the variations; and
determining an acceleration of the remote object parallel to the display device according to the difference of the variations.

13. The movement detecting method as recited in claim 9, wherein the determining step includes:
calculating variations of each of the coupling capacitances at different times;
calculating a sum of the variations; and
determining if the remote object approaches or leave the display device according to the sum of the variations.

14. The movement detecting method as recited in claim 9, wherein the determining step includes:
when at least one of the coupling capacitances is larger than a first base value, calculating a time difference between the times at which the coupling capacitances are larger than a threshold value; and
determining the moving direction of the remote object parallel to the display device according to the time difference; and
when the coupling capacitances are all larger than a second base value that is larger than the first base value,
calculating variations of each of the coupling capacitances at different times,
calculating a difference of the variations,
determining an acceleration of the remote object parallel to the display device according to the difference of the variations,
calculating a sum of the variations, and
determining if the remote object approaches or leave the display device according to the sum of the variations.

15. The movement detecting method as recited in claim 9, further comprising:
a selecting step selecting a first determining mode or a second determining mode according to the coupling capacitances,
wherein the determining step is operated according to the result of the selecting step.

16. The movement detecting method as recited in claim 15, wherein
when at least one of the coupling capacitances is larger than a first base value, the selecting step is to select the first determining mode; and
when the coupling capacitances are all larger than a second base value that is larger than the first base value, the selecting step is to select the second determining mode.

17. The movement detecting method as recited in claim 15, wherein the determining step operated in the first determining mode includes:
acquiring at least a corresponding time at which the coupling capacitances are larger than a threshold value;
acquiring a sequence of the corresponding times; and
determining the moving direction of the remote object parallel to the display device according to the sequence.

18. The movement detecting method as recited in claim 15, wherein the determining step operated in the first determining mode includes:
acquiring at least a corresponding time at which the coupling capacitances are larger than a threshold value;
calculating a time difference of the corresponding times; and
determining a velocity of the remote object according to the time difference.

19. The movement detecting method as recited in claim 15, wherein the determining step operated in the second determining mode includes:
calculating variations of each of the coupling capacitances at different times;
calculating a difference of the variations; and
determining an acceleration of the remote object parallel to the display device according to the difference of the variations.

20. The movement detecting method as recited in claim 15, wherein the determining step operated in the second determining mode includes:
calculating variations of each of the coupling capacitances at different times;
calculating a sum of the variations; and
determining if the remote object approaches or leave the display device according to the sum of the variations.
